(19) United States
(12) Patent Application Publication
(10) Pub. No.: US 2012/0045629 A1
(43) Pub. Date: Feb. 23, 2012

(54) Vinylhydrogenpolysiloxane Adhesive Composition

(76) Inventors: Nathan Greer, Freeland, MI (US); Marilyn Shope, Sanford, MI (US); Michitaka Suto, Midland, MI (US); Bianxiao Zhong, Midland, MI (US); Bizhong Zhu, Midland, MI (US)

(21) Appl. No.: 13/318,747

(22) PCT Filed: Apr. 6, 2010
(86) PCT No.: PCT/US2010/030023

§ 371 Date: Nov. 3, 2011

Related U.S. Application Data
(60) Provisional application No. 61/175,880, filed on May 6, 2009.

(51) Int. Cl. B32B 3/00; C09J 183/07

(52) U.S. Cl. 428/195.1; 528/31; 525/474

(57) ABSTRACT

Vinylhydrogenpolysiloxanes are provided. The vinylhydrogenpolysiloxanes comprise organopolysiloxanes having at least two silicon-bonded hydrogen atoms and at least two silicon-bonded vinyl groups. As a fraction of the total number of silicon atoms in the vinylhydrogenpolysiloxanes, about 25% to about 90% of the silicon atoms are bonded to a hydrogen atom and about 10% to about 45% are bonded to a vinyl group. The ratio of the number of silicon-bonded hydrogen groups to the number of silicon-bonded vinyl groups is about 1.3 to about 6. Also provided are silicone compositions comprising at least one vinylhydrogenpolysiloxane and a hydrosilylation catalyst; silicone adhesives comprising a cured product of at least one vinylhydrogenpolysiloxane; and laminates comprising at least one such silicone adhesive. When subjected to high temperatures or direct flame, the vinylhydrogenpolysiloxanes form chars that retain adhesion to various substrates.

The present invention relates generally to adhesive compositions and particularly to adhesive compositions comprising vinylhydrogenpolysiloxanes.

Silicone adhesives are useful in a variety of applications by virtue of their unique combination of properties, including high thermal stability, good moisture resistance, excellent flexibility, high ionic purity, low alpha-particle emissions, and good adhesion to various substrates. For example, silicone adhesives are widely used in the automotive, electronic, construction, appliance, and aerospace industries.

However, when conventional silicone adhesives are exposed to high temperatures, for example temperatures encountered by direct contact with an open flame, the adhesives decompose to form a char. The char typically is a powder that renders the adhesive incapable of adhering to a substrate.

In view of the foregoing, there is a need for a silicone composition that cures to form an adhesive retaining high adhesion during and after exposure to temperatures above the decomposition temperature of the adhesive.

The needs addressed above are met through the various embodiments of the present invention, wherein vinylhydrogenpolysiloxanes are provided. The term “vinylhydrogenpolysiloxanes” herein refers to organopolysiloxanes containing both Si—H units (for example, MeHSiO_{2/2} and HMe₂SiO_{1/2}) and Si-Vi units (for example, ViMeSiO_{2/2}, ViMe₂SiO_{1/2}, and ViSiO_{3/2}). The vinylhydrogenpolysiloxanes of the present invention contain at least two Si—H units and at least two Si-Vi units per molecule. The vinylhydrogenpolysiloxanes form a ceramic char in high yields when subjected to fire or a high temperature in air of, for example, about 500° C. to about 1000° C., depending on the specific composition of the vinylhydrogenpolysiloxanes. However, the ceramic char retains adhesion to various substrates in a temperature range of about 700° C. to about 1000° C. Therefore, the vinylhydrogenpolysiloxanes and compositions comprising them may be useful, for example, in adhesives for fire-rated glass, such as glass used in doors, windows, and firewalls.

According to one embodiment of the present invention, a vinylhydrogenpolysiloxane is provided. The vinylhydrogenpolysiloxane has per molecule an average of at least two silicon-bonded hydrogen atoms and at least two silicon-bonded vinyl groups. Of the total number of silicon atoms in the molecule, 25% to 90% are bonded to a hydrogen atom and 10% to 45% are bonded to a vinyl group. Furthermore, the mole ratio of the silicon-bonded hydrogen atoms to the silicon-bonded vinyl groups is from 1.3 to 6.

According to another embodiment of the present invention, a silicone composition is provided. The silicone composition comprises, (A) a vinylhydrogenpolysiloxane as describe above; and (B) a hydrosilylation catalyst.

According to yet another embodiment of the present invention, a silicone adhesive is provided. The adhesive comprises a cured product of at least one vinylhydrogenpolysiloxane as described above.

According to yet another embodiment of the present invention, a laminate is provided. The laminate comprises a first substrate, at least one additional substrate overlying the first substrate, and a silicone-adhesive coating bonding adjacent substrates. The substrates may comprise any rigid or flexible material having a planar, complex, or irregular contour. The adhesive coating is on at least a portion of at least one surface of each substrate, provided at least a portion of the adhesive coating is between and in direct contact with opposing surfaces of the adjacent substrates. The adhesive coating comprises at least one silicone adhesive as described above and may be a single-layer or a multiple-layer coating. The laminate remains bonded when exposed to high or intense heat, including direct exposure to flame, for example, from 700° C. to 1000° C.

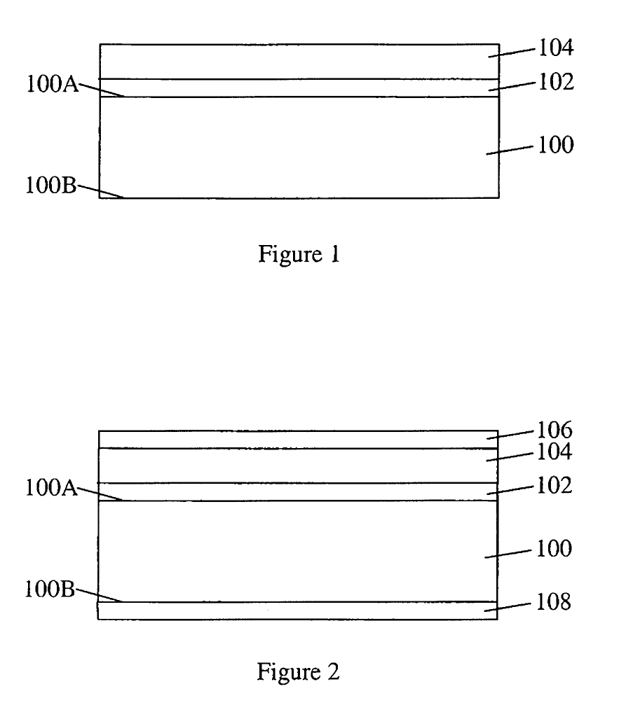

FIG. 1 shows a cross-sectional view of one embodiment of a laminate according to the present invention.

FIG. 2 shows a cross-sectional view of the previous embodiment of the laminate, further comprising a second silicone adhesive coating on the second substrate and a third silicone adhesive coating on the second opposing surface of the first substrate.

Features and advantages of the invention will now be described with occasional reference to specific embodiments. However, the invention may be embodied in different forms and should not be construed as limited to the embodiments set forth herein. Rather, these embodiments are provided so that this disclosure will be thorough and complete and will fully convey the scope of the invention to those skilled in the art.

Unless otherwise indicated, all numbers expressing quantities, properties, weight, conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

Vinylhydrogenpolysiloxanes according to embodiments of the present invention are polysiloxanes comprising both silicon atoms bonded to hydrogen atoms (Si—H units) and silicon atoms bonded to vinyl groups (Si-Vi units). Each molecule contains an average of at least two Si—H units and at least two Si-Vi units. Furthermore, each molecule defines a mol. % Si—H, a mol. % Si-Vi, and a mole ratio Si—H/Si-Vi. The mol. % Si—H is defined as the ratio of the number of moles of Si—H units in the molecule to the total number of moles of silicon in the molecule. Similarly, the mol. % Si-Vi is defined as the ratio of the number of moles of Si-Vi units in the molecule to the total number of moles of silicon in the molecule. The ratio Si—H/Si-Vi is defined as the ratio of mol. % Si—H to mol. % Si-Vi. The vinylhydrogenpolysiloxanes may comprise silicon-bonded atoms and groups that are neither hydrogen nor vinyl, as will be described below.

The vinylhydrogenpolysiloxanes according to embodiments of the present invention may be linear, cyclic, branched, hyperbranched, lightly-crosslinked network, or a mixture of any of these, and may range in size from oligomers up to and including high molecular-weight polymers. For example, the vinylhydrogenpolysiloxanes may have weight-average molecular weights (M_{W}) of from 300 to 1,000,000; alternatively from 500 to 500,000; alternatively from 1,000 to 100,000; alternatively from 2,000 to 50,000; alternatively from 3,000 to 25,000.

Expressed as an average formula, the vinylhydrogenpolysiloxanes according to embodiments of the present invention may be represented, for example, as Formula (I):

[(R²SiO_{(3-m)/2})(OH)ₘ]ₓ[(R³R¹SiO_{2-n)/2})(OH)ₙ]_{y}(R⁴R¹₂SiO_{1/2})_{z}, (I)

where each R¹ is C₁₋₆ hydrocarbyl or halogen-substituted C₁₋₆ hydrocarbyl, both free of aliphatic unsaturation; each R² is independently vinyl or R⁵; each R³ is independently hydrogen, vinyl, or R⁵; each R⁴ is independently hydrogen, vinyl, or R¹; each R⁵ is independently C₁₋₁₀ hydrocarbyl or halogen-substituted C₁₋₁₀ hydrocarbyl, both free of aliphatic unsaturation; x is from 0 to 0.50; y is from 0.50 to 0.999; z is from 0.001 to 0.20; x+y+z≈1; and m and n each are independently from 0 to 0.05.

Also in Formula (I), all variables are defined further with the provisos that, (1) the vinylhydrogenpolysiloxane comprises at least two Si—H units and at least two Si-Vi units; (2) mol. % Si—H (as defined above) is 25% to 90%, alternatively 25% to 86%, alternatively 25% to 80%, alternatively 25% to 72%, alternatively 40% to 90%, alternatively 40% to 86%, alternatively 40% to 80%, alternatively 40% to 72%; (3) mol. % Si-Vi (as defined above) is 10% to 45%, alternatively 10% to 40%, alternatively 10% to 35%, alternatively 10% to 30%, alternatively 20% to 45%, alternatively 20% to 40%, alternatively 20% to 35%; and (4) the ratio Si—H/Si-Vi (as defined above) is from 1.3 to 6, alternatively from 1.5 to 4, alternatively from 1.8 to 2.5.

The C₁₋₆ hydrocarbyl and halogen-substituted hydrocarbyl groups represented by R¹ are free of aliphatic unsaturation and typically have from 1 to 6 carbon atoms. Acyclic hydrocarbyl and halogen-substituted hydrocarbyl groups containing at least 3 carbon atoms can have a branched or unbranched structure. Examples of hydrocarbyl groups represented by R¹ include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, and hexyl; cycloalkyl, such as cyclopentyl and cyclohexyl. Examples of halogen-substituted C₁₋₆ hydrocarbyl groups represented by R¹ include, but are not limited to, 3,3,3-trifluoropropyl, 3-chloropropyl, chlorophenyl, dichlorophenyl, 2,2,2-trifluoroethyl, 2,2,3,3-tetrafluoropropyl, and 2,2,3,3,4,4,5,5-octafluoropentyl.

The C₁₋₁₀ hydrocarbyl and halogen-substituted hydrocarbyl groups represented by R⁵ also are free of aliphatic unsaturation but may have from 1 to 10 carbon atoms. Typically, however, if more than 6 carbon atoms are present, at least 4, alternatively at least 6, of the carbon atoms are members of a ring structure. Thus, in addition to the groups described above for R¹, the R⁵ groups may comprise further groups such as, for example, methylcyclohexyl; dimethylcyclohexyl; naphthyl; tolyl; xylyl; phenethyl; 2-phenylpropyl; 1-phenylpropyl; t-butylphenyl; norbornyl; or trifluoromethylcyclohexyl.

In Formula (I), the subscripts x, y, and z are mole fractions of all groups in the vinylhydrogenpolysiloxane conforming to the formula to which the applicable subscript refers. Thus, it will be apparent that even though a single vinylhydrogenpolysiloxane molecule may contain, for example, multiple groups (R²SiO_{(3-m)/2})(OH)ₘ, the selections of R² and m need not be the same in every such group, as long as the total mole fraction of all such groups equals the value chosen for x. The subscript x typically has a value of from 0 to 0.50; the subscript y typically has a value of from 0.50 to 0.999; and the subscript z typically has a value of from 0.001 to 0.20.

Also, in Formula (I) the subscripts m, and n are fractions that represent the average number of hydroxy groups associated with the various units in the formula. The subscript m typically has a value of from 0 to 0.05, alternatively from 0.01 to 0.04, alternatively from 0.01 to 0.03; the subscript n typically has a value of from 0 to 0.05, alternatively from 0.01 to 0.03, alternatively from 0.01 to 0.02.

It will be understood that small amounts of hydroxyl, alkoxy, haloalkyl, and so forth may be present in the vinylhydrogenpolysiloxanes so long as there is no resulting adverse effects to the adhesive and high-temperature properties of the vinylhydrogenpolysiloxanes, of compositions comprising the vinylhydrogenpolysiloxanes, of adhesives comprising the compositions, and of laminates prepared comprising the adhesives.

In exemplary embodiments not intended to be limiting, all groups R¹ of the vinylhydrogenpolysiloxanes of Formula (I) may be represented as methyl groups, and the resulting average formula of such exemplary embodiments may be expressed, for example, as Formula (II):

[(R²SiO_{(3-m)/2})(OH)ₘ]ₓ[(R³MeSiO_{(2-n)/2})(OH)ₙ]_{y}(R⁴Me₂SiO_{1/2})_{z}. (II)

Only for the sake of illustrating Si—H, Si-Vi, and Si—H/Si-Vi in the exemplary embodiments, in Formula (II), let each R² be independently vinyl, phenyl, or methyl; each R³ be independently vinyl, hydrogen, phenyl, or methyl; each R⁴ be independently vinyl, hydrogen, or methyl; and m, n, x, y, and z be the same as in Formula (I) above. Moreover, these variables are defined with the same provisos as those of the vinylhydrogenpolysiloxanes of Formula (I) above.

Thus, illustrative examples of vinylhydrogenpolysiloxanes according to these exemplary embodiments include molecules such as the following:

### (a) (HMeSiO_{2/2})_{0.64}(ViMeSiO_{2/2})_{0.33}(HMe₂SiO_{1/2})_{0.03}

### (b) (HMeSiO_{2/2})_{0.50}(ViMeSiO_{2/2})_{0.27}(PhMeSiO_{2/2})_{0.20}(Me₃SiO_{1/2})_{0.03}

### (c) (ViSiO_{3/2})_{0.26}(HMeSiO_{2/2})_{0.40}(PhMeSiO_{2/2})_{0.20}(HMe₂SiO_{1/2})_{0.14}

### (d) (MeSiO_{3/2})_{0.04}(HMeSiO_{2/2})_{0.44}(ViMeSiO_{2/2})_{0.25}(PhMeSiO_{2/2})_{0.22}(HMe₂SiO_{1/2})_{0.05}

### (e) (PhSiO_{3/2})_{0.10}(ViSiO_{3/2})_{0.05}(HMeSiO_{2/2})_{0.61}(ViMeSiO_{2/2})_{0.15}(HMe₂SiO_{1/2})_{0.09}

In illustrative example (a), mol. % Si—H is 67% (64%+3%), mol. % Si-Vi is 33%, and Si—H/Si-Vi is 2.03. In illustrative example (b), mol. % Si—H is 50%, mol. % Si-Vi is 27%, and Si—H/Si-Vi is 1.85. In illustrative example (c), mol. % Si—H is 54% (40%+14%), mol. % Si-Vi is 26%, and Si—H/Si-Vi is 2.08. In illustrative example (d), mol. % Si—H is 49% (44%+5%), mol. % Si-Vi is 25%, and Si—H/Si-Vi is 1.96. In illustrative example (e), mol. % Si—H is 70% (61%+9%), mol. % Si-Vi is 20% (5%+15%), and Si—H/Si-Vi is 3.50.

Vinylhydrogenpolysiloxane polymers according to embodiments of the invention may be prepared by cohydrolyzing an appropriate mixture of chlorosilane precursors in an organic solvent such as toluene. For example, any silicone polymer consisting essentially of HMeSiO_{2/2}, HMe₂SiO_{1/2}, ViMeSiO_{2/2}, and ViSiO_{3/2} units can be prepared by cohydrolyzing in toluene a compound having the formula MeHSiCl₂, a compound having the formula MeViSiCl₂, a compound having the formula Me₂HSiCl, and a compound having the formula ViSiCl₃. From the hydrolysis mixture, the aqueous hydrochloric acid and silicone hydrolyzate are separated. The hydrolyzate then is washed with water to remove residual acid and is heated in the presence of a mild, non-basic condensation catalyst to “body” the polymer to the requisite viscosity. If desired, the polymer can be treated further with a non-basic condensation catalyst in an organic solvent to condense and reduce the content of silicon-bonded hydroxy groups. Alternatively, silanes containing hydrolysable groups other than chloro, such as —Br, —I, —OCH₃, —O(C₂H₅)₃, —OC(O)CH₃, —N(CH₃)₂, —NHCOCH₃, and —SCH₃ can be used as starting materials in the cohydrolysis reaction. The properties of the products depend on the types of silanes, the mole ratio of silanes, the degree of condensation, and the processing conditions.

Embodiments of the invention are directed further to a silicone composition comprising (A) a vinylhydrogenpolysiloxane; and (B) a hydrosilylation catalyst, wherein component (A) of the silicone composition is a vinylhydrogenpolysiloxane as described in any of the previous embodiments.

Component (B) of the silicone composition is a hydrosilylation catalyst that initiates the hydrosilylation reaction between the silicon-bonded hydrogen atoms and vinyl groups in component (A). Known hydrosilylation catalysts can be used as component (B), which are specifically exemplified by platinum compounds such as chloroplatinic acid and its alcohol solutions, olefin complexes of platinum, diketone complexes of platinum, acetylacetate complexes of platinum, and complexes of platinum with vinyl-functional siloxane. In addition to platinum compounds, this catalyst is exemplified also by rhodium compounds such as the triphenylphosphine complex of rhodium; palladium compounds such as the tetrakis(triphenylphosphine)palladium complex; radical generators such as peroxides and azo compounds; and compounds of ruthenium, iridium, iron, cobalt, manganese, zinc, lead, aluminum, and nickel. Depending on the particular circumstances, a single catalyst can be used or two or more different catalysts can be used in combination. Among the various possibilities, platinum compounds are optimal because they exhibit excellent activity in the reaction under consideration.

Component (B) is typically present in a catalytic quantity, which is the smallest amount sufficient for inducing the addition reaction. In the case of platinum compounds, component (B) is preferably present in a concentration of from 0.01 to 1,000 weight parts as platinum per 1,000,000 weight parts of component (A) and more preferably from 0.1 to 100 weight parts as platinum per 1,000,000 weight parts of component (A).

Compositions according to these embodiments, which comprise generally components (A) and (B) as described above, may contain additional compounds such as hydrosilylation-catalyst inhibitors, adhesion promoters, dyes, pigments, antioxidants, heat stabilizers, UV stabilizers, flame retardants, flow-control additives, fillers, diluents, or any of combination of these, provided such additional compounds do not prevent the vinylhydrogenpolysiloxane from curing to form an adhesive with high char-yield and high adhesion during and after exposure to temperatures above the decomposition temperature of the adhesive.

Examples of hydrosilylation-catalyst inhibitors include, but are not limited to, phosphorus compounds such as triphenylphosphines; nitrogen compounds such as tributylamine, tetramethylethylenediamine, and benzotriazole; sulfur-containing compounds; acetylenic compounds; acetylenic alcohols; compounds that contain at least two alkenyl groups; alkynyl-functional compounds; hydroperoxy compounds; and maleic acid derivatives. The following are preferred inhibitors: diesters of maleic acid; compounds that contain both alkynyl and alcoholic hydroxyl in the individual molecule (for example, 3,5-dimethyl-1-hexyn-3-ol, 2-phenyl-3-butyn-2-ol, and 1-ethynyl-1-cyclohexanol); compounds that contain two or more alkynyl groups in the individual molecule; compounds that contain at least two alkenyl groups, such as 1,3-divinyl-1,1,3,3-tetramethyldisiloxane; vinylcyclosiloxanes; triphenylphosphines; 3-methyl-3-penten-1-yne; and 3,5-dimethyl-3-hexen-1-yne.

If a hydrosilylation-catalyst inhibitor is used during the synthesis of the vinylhydrogenpolysiloxanes of the present invention, the concentration of the inhibitor is preferably from 0.1 to 50,000 weight parts for each 1,000,000 weight parts of the polymer. If the concentration of the inhibitor is too high, the inhibitor will inhibit the curing process.

Exemplary reactive diluents include, but are not limited to, silanes or siloxanes, either of which may comprise alkenyl groups, silicon-bonded hydrogen groups, or mixtures thereof.

Exemplary fillers include, but are not limited to, inorganic fillers such as oxides, nitrides, sulfates, phosphates, carbonates, or mixtures of any of these; and organic fillers such as PTFE, polystyrene, silicone elastomer powders, or mixtures of these.

The silicone composition typically does not contain an organic solvent. However, the composition may further comprise an organic solvent to reduce the viscosity of the composition or to facilitate application of the composition on a substrate.

The silicone composition may be prepared by combining the principal components and any optional ingredients in the stated proportions at ambient temperature, with or without the aid of an organic solvent. Although the order of addition of the various components is not critical if the silicone composition is to be used immediately, the hydrosilylation catalyst preferably is added last at a temperature below about 30° C. to prevent premature curing of the composition.

Mixing can be accomplished by any of the techniques known in the art such as milling, blending, and stirring, either in a batch or continuous process. The particular mixing device is determined by the viscosity of the components and the viscosity of the final silicone composition.

Embodiments of the present invention are directed further to silicone adhesives. The silicone adhesives each comprise a cured product of at least one vinylhydrogenpolysiloxane as described and exemplified above. The term “cured product of at least one vinylhydrogenpolysiloxane” refers to a cross-linked polysiloxane derived from at least one vinylhydrogenpolysiloxane according to embodiments of the present invention and having a three-dimensional network structure.

The silicone adhesives typically have high transparency that depends on a number of factors, such as the composition and thickness of the adhesive. For example, a silicone adhesive film having a thickness of 50 μm typically has a transmittance of at least 80%, alternatively at least 90%, for light in the visible region (˜400 nm to ˜700 nm) of the electromagnetic spectrum.

The silicone adhesives can be prepared by curing a silicone composition comprising a vinylhydrogenpolysiloxane, such silicone composition being described above. The silicone composition can be cured by exposure to a temperature of from room temperature (23±2° C.) to 250° C., alternatively from room temperature to 200° C., alternatively from room temperature to 150° C., at atmospheric pressure. The silicone composition generally is heated for a length of time sufficient to cure (cross-link) the vinylhydrogenpolysiloxane. For example, the composition typically is heated at a temperature of from 150° C. to 200° C. for 0.1 hours to 3 hours.

Owing to their vinylhydrogenpolysiloxane components, the silicone adhesives according to embodiments of the present invention form ceramic chars in high yields when subjected to fire or a high temperature in air of, for example, about 500° C. to about 1000° C., depending on the specific composition of the vinylhydrogenpolysiloxanes. The ceramic char is capable of retaining adhesion to various substrates in a temperature range of about 700° C. to about 1000° C.

Embodiments of the present invention relate further to a laminate comprising a first substrate, at least one additional substrate overlying the first substrate, and a silicone adhesive coating that bonds adjacent substrates. As used herein, the term “overlying” means each additional substrate occupies a position over, but not in direct contact with, the first substrate and any one or more intervening substrates.

The substrates can be any rigid or flexible material having a planar, complex, or irregular contour. The substrates can be transparent or nontransparent to light in the visible region (˜400 nm to ˜700 nm) of the electromagnetic spectrum. Also, the substrates can be an electrical conductor, semiconductor, or nonconductor. Examples of substrates include, but are not limited to, semiconductors such as silicon, silicon having a surface layer of silicon dioxide, silicon carbide, indium phosphide, and gallium arsenide; quartz; fused quartz; aluminum oxide; ceramics; glass such as soda-lime glass, borosilicate glass, lead-alkali glass, borate glass, silica glass, aluminosilicate glass, lead-borate glass, sodium borosilicate glass, lithium aluminosilicate glass, chalcogenide glass, phosphate glass, and alkali-barium silicate glass; metal foils; polyolefins such as polyethylene, polypropylene, polystyrene, polyethylene terephthalate (PET), and polyethylene naphthalate; fluorocarbon polymers such as polytetrafluoroethylene and polyvinylfluoride; polyamides such as Nylon; polyimides; polyesters such as poly(methyl methacrylate); epoxy resins; silicone resins; polyethers; polycarbonates; polysulfones; and polyether sulfones.

In addition, one or more substrates can be a reinforced polymer film, for example, a reinforced silicone-resin film. A reinforced silicone-resin film may be prepared by impregnating a fiber reinforcement such as woven or nonwoven glass fabric, or loose glass fibers, in a curable silicone composition comprising a silicone resin. The fiber-impregnated silicone resin composition is then heated to cure the silicone resin. Reinforced silicone resin films prepared from various types of curable silicone compositions are known in the art, as exemplified in the following International Patent Application Publications: WO2006/088645, WO2006/088646, WO2007/092032, and WO2007/018756.

The laminate typically contains from 1 to 20 additional substrates, alternatively from 1 to 10 additional substrates, alternatively from 1 to 4 additional substrates. When the laminate is a laminated glass, at least one of the substrates is glass and, optionally, at least one of the substrates is a reinforced silicone resin film, described above.

The silicone adhesive coating of the laminate is on at least a portion of at least one surface of each substrate, provided at least a portion of the silicone adhesive coating is between and in direct contact with opposing surfaces of the adjacent substrates. The silicone adhesive coating comprises at least one silicone adhesive as provided in previous embodiments. Because the vinylhydrogenpolysiloxane component of the adhesive forms a char that retains adhesion at high temperatures, the laminate remains bonded when exposed to a fire or high temperature. In one embodiment, the laminate remains bonded after direct exposure to a flame source of about 700° C. to about 1000° C. for at least 30 to 120 minutes.

The silicone adhesive coating can be a single-layer coating comprising one layer of a silicone adhesive, or a multiple-layer coating comprising two or more layers of at least two different silicone adhesives. In a multiple-layer coating, directly adjacent layers may comprise different silicone adhesives. As used here, the term “different”, means that each of the at least two silicone adhesives (1) has a cured composition that is not equal to that of any other of the at least two silicone adhesives, (2) exhibits properties with respect to its curing that differ from the properties of any other of the at least two silicone adhesives, or (3) both (1) and (2). The multiple-layer coating may comprise, for example, from 2 to 7 layers, from 2 to 5 layers, or from 2 to 3 layers; however, any number of layers is foreseeable within the scope of the present invention, as long as the total thickness of the multiple-layer coating does not exceed approximately 10 mm.

A single-layer silicone adhesive coating may have a thickness of, for example, from 0.03 μm to 10 mm, from 0.1 μm to 1 mm, or from 1 μm to 10 μm. A multiple-layer coating may have a total thickness of, for example, from 0.06 μm to 1 mm, from 0.2 μm to 2 mm, or from 1 μm to 150 μm. When the total thickness of the silicone adhesive coating is less than 0.03 μm, the coating may become discontinuous. When the total thickness of the silicone adhesive coating is greater than 10 mm, the coating may exhibit reduced adhesion, cracking, or both.

To form the laminate, initially a silicone-adhesive coating is applied on at least a portion of at least one surface of a first substrate, the silicone adhesive and the substrate being as defined and exemplified above. The silicone composition can be applied on the substrate using conventional methods such as spin coating, dip coating, spray coating, flow coating, screen printing, and roll coating. When present, the solvent is typically allowed to evaporate from the coated substrate before the film is heated. Any suitable means for evaporation may be used such as simple air drying, applying a vacuum, or heating (up to 50° C.). The adhesive coating may be applied onto a portion of one or more surfaces of the substrate or on all of one or more surfaces of each substrate. For example, when the laminate is a laminated glass comprising glass panes, the silicone adhesive coating may be on one side, on both sides, or on both sides and the edges, of each pane. Thereupon, an additional substrate may be applied on the adhesive coating, and the adhesive may be cured. Further additional substrates may be applied by repeating the coating process on the topmost substrate, then applying the further additional substrate.

Optionally, the thickness of the applied silicone-adhesive coating can be increased by repeating one or more times the following steps, omitting step (ii) on the final repeat to leave the topmost layer uncured in preparation for applying an additional substrate of the laminate: (i) applying a silicone composition comprising a vinylhydrogenpolysiloxane, described above, on a substrate to form a single-layer or a multiple-layer coating, and (ii) curing the silicone composition of the coating under the conditions described above in the method of preparing the silicone adhesive. In such a case, the silicone composition is applied on the cured adhesive film rather than the substrate, and the same silicone composition is used for each application.

Multiple-layer silicone-adhesive coatings can be prepared in a manner similar to the method used to prepare a single-layer coating, except that adjacent layers of the coating are prepared using a silicone adhesive having a different composition or different cured properties from each other. In such a preparation, typically each silicone-adhesive coating is at least partly cured before the silicone adhesive of the next layer is applied. For example, a coated substrate comprising a silicone adhesive coating having two layers can be prepared by (i) applying a silicone composition, described above, on a substrate to form a first coating, (ii) at least partially curing the vinylhydrogenpolysiloxane polymer of the first coating, (iii) applying a silicone composition different from the composition in (i) on the partially cured first coating to form a second coating, and (iv) curing the vinylhydrogenpolysiloxane polymer of the second coating. Steps (ii) through (iv) may be repeated as desired to form a silicone-adhesive coating comprising three or more layers. In all instances, step (iv) is omitted on the final repeat of the coating process to leave the topmost layer uncured in preparation for applying the next substrate of the laminate.

As shown in FIG. 1, one embodiment of a laminate according to the present invention comprises a first substrate 100 having a first opposing surface 100A and a second opposing surface 100B; a first silicone adhesive coating 102 on the first opposing surface 100A of the first substrate 100, wherein the first silicone adhesive coating 102 comprises a cured product of at least one vinylhydrogenpolysiloxane as provided above; and a second substrate 104 on the first silicone adhesive coating 102.

As shown in FIG. 2, where like reference numerals represent like elements, the preceding embodiment of the laminate can further comprise a second silicone adhesive coating 106 on the second substrate 104 and a third silicone adhesive coating 108 on the second opposing surface 100B of the first substrate 100, wherein the second and third adhesive coatings each comprise a cured product of at least one vinylhydrogenpolysiloxane polymer as described above.

A suitable method of preparing the laminate is illustrated here for the laminate depicted in FIG. 1. The laminate can be prepared by (i) applying a silicone composition, described above, on a first surface of a substrate to form a first adhesive film; (ii) applying a second substrate on the first adhesive film; and (iii) curing the vinylhydrogenpolysiloxane polymer of the first adhesive film. Laminates comprising additional silicone adhesive coatings and substrates can be prepared in a similar manner. When the laminate comprises at least one multiple-layer silicone adhesive coating, typically each layer of the coating is at least partially cured before the next layer is formed.

### EXAMPLES

The present invention will be better understood by reference to the following examples, which are offered by way of illustration and which one of skill in the art will recognize are not meant to be limiting.

Exemplary vinylhydrogenpolysiloxane compositions as embodied according to the present invention were prepared by the following method from starting materials listed in TABLE 1: (1) A mixture of silanes and toluene was slowly added to cooled de-ionized water with stiffing, while the reaction mixture temperature was controlled below 30° C. using an ice bath; (2) The reaction mixture was stirred for 10 minutes at 60° C. after the completion of addition; (3) The mixture was allowed to phase-separate in a separation funnel, the aqueous phase was drained, and the organic phase was washed four times with de-ionized water; (4) The washed solution was then heated to reflux in presence of 0.5 wt. % Dowex 2030 solid acid catalyst (a crosslinked, sulfonated polystyrene, trademark of Dow Corning) for 1 hour, while water was removed continuously using a Dean-Stark trap; (5) The solid catalyst was removed by filtration; (6) Toluene solvent was removed by vacuum stripping. Final products were clear liquids. Weight-average molecular weights (M_{W}), as determined by gel-permeation chromatography (GPC) against a polydimethylsiloxane (PDMS) reference, were recorded in TABLE 1. Amounts of starting materials, computed in terms of molar fraction, are recorded in TABLE 2.

TABLE 1
Starting materials and GPC M_{W} of vinylhydrogenpolysiloxanes according
to embodiments of the present invention. Amounts of starting materials
are shown as parts by weight.

| | | | | | | | | GPC |
|---|---|---|---|---|---|---|---|---|
| | MeHSiCl₂ | MeViSiCl₂ | MePhSiCl₂ | Me₂HSiCl | ViSiCl₃ | Water | Toluene | M_{W} |
| Ex.1 | 19.7 | 12.4 | 0 | 0.50 | 0 | 49.2 | 18.2 | 8690 |
| Ex.2 | 11.14 | 7.33 | 15.35 | 0.67 | 0 | 43.78 | 21.72 | 5620 |
| Ex.3 | 14.75 | 8.00 | 10.37 | 0.70 | 0 | 45.70 | 20.48 | 13613 |
| Ex.4 | 159.6 | 0 | 0 | 18.8 | 64 | 418.4 | 129 | |
| Ex.5 | 83.15 | 0 | 71.63 | 7.65 | 55.05 | 334.26 | 154.86 | |

TABLE 2
Starting materials expressed as molar fractions of initial reaction mixture.

| | MeHSiCl₂ | MeViSiCl₂ | MePhSiCl₂ | Me₂HSiCl | ViSiCl₃ | Si—H | Si—Vi | Si—H/Si—Vi |
|---|---|---|---|---|---|---|---|---|
| Ex.1 | 64.8% | 33.2% | 0.0% | 2.0% | 0.0% | 66.8% | 33.2% | 2.01 |
| Ex.2 | 41.0% | 22.0% | 34.0% | 3.0% | 0.0% | 44.0% | 22.0% | 2.00 |
| Ex.3 | 52.0% | 23.0% | 22.0% | 3.0% | 0.0% | 55.0% | 23.0% | 2.39 |
| Ex.4 | 70.0% | 0.0% | 0.0% | 10.0% | 20.0% | 80.0% | 20.0% | 4.00 |
| Ex.5 | 47.6% | 0.0% | 24.7% | 5.3% | 22.4% | 52.9% | 22.4% | 2.36 |

Adhesive samples were made in glass vials by combining 1.5 g of the above liquids and 0.01 g of Pt catalyst solution having a Pt concentration of 1000 ppm, cured at 150° C. for 15 minutes, and heated in air at 500° C. for 15 minutes. The weight loss after 500° C. heating was recorded in TABLE 3 for each sample.

TABLE 3
Summary of properties of vinylhydrogenpolysiloxane adhesives

| | | | Adhesion after |
|---|---|---|---|
| | Weight loss at | Laminate | 10-minute |
| | 500° C. in air | clarity | fire test |
| Example 1 | 2.4% | clear | good |
| Example 2 | 8% | clear | good |
| Example 3 | 3.6% | clear | good |
| Example 4 | 0% | clear | good |
| Example 5 | 2.2% | clear | good |
| Example 6 | | clear | no adhesion |
| (Comparative) | | | |
| Example 7 | | clear | poor |
| (Comparative) | | | |

Using each of the exemplified adhesives, 6″×6″ G/A/F/A/G laminates were prepared, where G represents ⅛″-thick float glass; A represents an adhesive composition prepared as described above; and F represents a reinforced film of Dow Corning 0-3015, (a toughened, low-viscosity, two-part silicone resin, trademark of Dow Corning). A selected adhesive was spread on two pieces of 6″×6″ glass, and laminates were made by sandwiching a film of Dow Corning 0-3015 silicone resin between the adhesive-coated glasses. The laminates were degassed in a mini-clave in vacuum for 2 hours and cured for 2 hours at 150° C. under 1 atm pressure while maintaining vacuum.

The cured laminates were inspected for optical transparency. Those with acceptably optical quality usually had visible light transmission of greater than 80%. They then were fired with a torch for 10 minutes, and the adhesion of the film to glass after the fire test was evaluated for retained adhesion.

Adhesion levels were assigned according to observation and recorded in TABLE. In TABLE 3 a “good” retained adhesion meant interlayer film remained strongly attached to at least one lite of the two glass plates, and at least some areas were observed to have both sides tightly bonded together after flame exposure. “No adhesion” meant both lites of glass came apart spontaneously after flame exposure. “Poor” meant only a small portion of a glass lite remained adhered to the interlayer.

As comparisons, laminates were made using conventional adhesives based on resins or polymers. The specific conventional adhesives used were (1) a peroxide cured polydimethylsiloxane, shown as Example 6 in TABLE 3, and (2) untreated Dow Corning 0-3015 resin, shown as Example 7 in TABLE 3. The comparative laminates did not retain any appreciable adhesion after being fired by a torch.

1. A vinylhydrogenpolysiloxane of the formula (I)
[(R²SiO_{(3-m)/2})(OH)ₘ]ₓ[(R³R¹SiO_{(2-n)/2})(OHₙ]_{y}(R⁴R¹₂SiO_{(1/2})_{z},
where R¹ is C₁₋₆ hydrocarbyl or halogen-substituted C₁₋₆ hydrocarbyl, both free of aliphatic unsaturation; each R² is independently vinyl or R⁵; each R³ is independently hydrogen, vinyl, or R⁵; each R⁴ is independently hydrogen, vinyl, or R¹; each R⁵ is independently C₁₋₁₀ hydrocarbyl or halogen-substituted C₁₋₁₀ hydrocarbyl, both free of aliphatic unsaturation; x is from 0 to 0.50; y is from 0.5 to 0.999; z is from 0.001 to 0.20; x+y+z≈1; and In, and n each are independently from 0 to 0.05, wherein
the vinylhydrogenpolysiloxane comprises at least two silicon-bonded hydrogen atoms and at least two silicon-bonded vinyl groups;
of the total number of groups R², R³, and R⁴ in the vinylhydrogenpolysiloxane, 25% to 90% of said groups are hydrogen, 10% to 45% of said groups are vinyl, and the ratio of the number of that are hydrogen to the number of said groups that are vinyl is from 1.3 to 6; and
the weight-average molecular weight of the vinylhydrogenpolysiloxane is from 300 g/mol to 1,000,000 g/mol.

2. The vinylhydrogenpolysiloxane of claim 1, wherein, of the total number of groups R², R³, and R⁴ in the vinylhydrogenpolysiloxane, 40% to 72% of said groups are hydrogen, 20% to 35% of said groups are vinyl, and the ratio of the number of said groups that are hydrogen to the number of said groups that are vinyl is from 1.8 to 2.5.

3. The vinylhydrogenpolysiloxane of claim 1, wherein
each group R′ is methyl;
each group R² is independently selected from vinyl, phenyl, or methyl;
each group R³ is independently selected from vinyl, hydrogen, phenyl, or methyl; and
each group R⁴ is independently selected from vinyl, hydrogen, or methyl.

4. The vinylhydrogenpolysiloxane of claim 3, wherein, of the total number of groups R², R³, and R⁴ in the vinylhydrogenpolysiloxane, 25% to 80% of said groups are hydrogen, 10% to 40% of said groups are vinyl, and the ratio of the number of said groups that are hydrogen to the number of said groups that are vinyl is from 1.5 to 4.

5-7. (canceled)

8. A silicone composition, comprising:
(A) at least one vinylhydrogenpolysiloxane according to claim 1; and
(B) at least one hydrosilylation catalyst.

9. (canceled)

10. The silicone composition of claim 8 wherein the silicone composition does not contain an organic solvent.

11. A silicone adhesive comprising a cured product of at least one vinylhydrogenpolysiloxane according to claim 1.

12. The silicone adhesive of claim 11, wherein for the vinylhydrogenpolysiloxane
each group R′ is methyl;
each group R² is independently selected from vinyl, phenyl, or methyl;
each group R³ is independently selected from vinyl, hydrogen, phenyl, or methyl; and
each group R⁴ is independently selected from vinyl, hydrogen, or methyl.

13. The silicone adhesive of claim 12, wherein, of the total number of groups R², R³, and R⁴ in the vinylhydrogenpolysiloxane, 25% to 80% of said groups are hydrogen, 10% to 40% of said groups are vinyl, and the ratio of the number of said groups that are hydrogen to the number of said groups that are vinyl is from 1.5 to 4.

14-16. (canceled)

17. A laminate, comprising:
a first substrate;
at least one additional substrate overlying the first substrate; and
a silicone adhesive coating bonding adjacent substrates, wherein:
the silicone adhesive coating comprises a cured product of at least one vinylhydrogenpolysiloxane according to claim 1; and
the silicone adhesive coating is on at least a portion of at least one surface of each substrate, provided at least a portion of the adhesive coating is between and in direct contact with opposing surfaces of the adjacent substrates.

18. The laminate of claim 17, wherein for the vinylhydrogenpolysiloxane
each group R′ is methyl;
each group R² is independently selected from vinyl, phenyl, or methyl;
each group R³ is independently selected from vinyl, hydrogen, phenyl, or methyl; and
each group R⁴ is independently selected from vinyl, hydrogen, or methyl.

19. The laminate of claim 17, wherein the laminate contains from 1 to 50 of the additional substrates.

20. The laminate of claim 17, wherein at least one of the substrates is a glass, an unreinforced polymer film, or a reinforced polymer film.

21. (canceled)

22. The laminate of claim 17 wherein at least one of the substrates is a silicone-resin film.

23. (canceled)

24. The laminate of claim 17 wherein at least one of the substrates is a reinforced silicone-resin film.

25. The laminate of claim 17, wherein the silicone-adhesive coating is a single-layer coating.

26. The laminate of claim 25, wherein the single-layer coating has a thickness of from 0.1 μm to 1 mm.

27. The laminate of claim 17, wherein the silicone-adhesive coating is a multiple-layer coating comprising at least one layer of a first silicone adhesive and at least one layer of at least one second adhesive, the at least one second silicone adhesive having a different composition or different cured properties from the first silicone adhesive.

28. The laminate of claim 27, wherein the multiple-layer coating is a two-layer coating, a three-layer coating, a four-layer coating, a five-layer coating, a six-layer coating, or a seven-layer coating.

29-30. (canceled)

31. The laminate of claim 27, wherein the multiple-layer coating has a thickness of from 0.2 μm to 2 mm.
